(19) United States
(12) Patent Application Publication
(10) Pub. No.: US 2008/0306909 A1
(43) Pub. Date: Dec. 11, 2008

(54) INTELLIGENT DOWNLOAD OF MEDIA FILES TO PORTABLE DEVICE

(75) Inventors: Peter Andrew Bernard, Bellevue, WA (US); James Farquharson Pratt, Seattle, WA (US); Sandra Irene Vargas, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/760,187

(22) Filed: Jun. 8, 2007

(51) Int. Cl. G06F 17/30

(52) U.S. Cl. 707/3; 707/10; 707/E17.101

(57) ABSTRACT

Systems and methods that intelligently download media files from a repository to a portable device of a user (e.g., cell phone), via an intelligent download engine and based on likelihood that such downloaded files are of interest to the user. Accordingly, from a user's perspective a seamless access to music depository is provided (e.g., typically all files of the depository seem to be virtually present on the portable device), and a user's manual interaction (e.g., selection of files based on memory requirement of the portable unit) is mitigated.

### BACKGROUND

With the proliferation of digital media, it is common for both home personal computer (PC) users and professionals to access and manage large numbers of media items (e.g., digital audio, digital video, electronic books, digital images and the like). Digital media permits users to have access to numbers and amounts of media on a scale not previously seen. Digital media can be stored and accessed on storage devices such as hard drives, DVD drives and the like and can also be stored and accessed across network(s) (e.g., Internet). Digital media is also employed in portable devices such as personal digital assistants (PDA), portable audio players, portable electronic book readers and the like.

However, such proliferation of media has also created problems in that the vast amounts of available media can overwhelm users. Users can find it difficult to organize, categorize and maintain large amounts of media. As an example, a single compact disk (CD) containing MPEG layer three (mp3) digital audio files can include about 140 songs. In contrast, a conventional compact disc-digital audio (CDDA) disc or audio tape typically includes about 10 songs. A user can generally remember the songs on an audio tape but is not likely to remember all 140 songs on the mp3 CD. Furthermore, portable digital audio devices can include 10 gigabytes or more of storage which permits for storing about 2,000 compressed digital songs. Additionally, storage device capacities are constantly increasing further affording for storing ever greater numbers of media items (e.g., an 80 gigabyte drive can generally store 16,000 songs) thereby exacerbating the difficulties related to accessing and categorizing numerous media items.

Moreover, identifying media items that match user preferences (e.g., mood, likes, dislikes) is also difficult. Users typically prefer certain types or categories of media items at different times and/or occasions (e.g., after work, party, relaxing and the like). Consequently, a user is often required to remember or search through an entire collection of media items (e.g., songs) to locate appropriate song(s) that are coincident with the user's current mood. As the collection of media items grows, the level of effort required to effect such searching also increases.

One mechanism that is employed to organize and identify media items is a play list, which is simply a list of media items organized in a particular order. A user can create different play lists for different moods and/or styles (e.g., dance music, classical, big band, country and the like). Play lists are helpful in connection with organizing media items, but can be difficult to generate and maintain. Generally, a user is required to manually locate songs having similar properties (e.g., artist, country, heavy metal and the like) and combine them into a single play list. Then, in order to modify or update the play list (e.g., because new items have been added to the collection), the user is required to manually add or remove items from the play list. Some approaches for automatically generating play list(s) have been attempted, but generally result in play lists that inadequately represent preferences of user(s).

Moreover, conventional methods of downloading and synchronization of media files typically requires users to explicitly select which files were to be synchronize, calculate available space on the target device, and then manually (via push button) load the device “full” with content. The content on the device remains static until the process is repeated. Such requires various acts to be performed, and can further deter discovery and use of content as libraries expand.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides for systems and methods that intelligently download media files (e.g., music) from a depository to a portable device of a user (e.g., cell phone), via an intelligent download engine and based on likelihood that such downloaded media file is of interest to the user. Accordingly, from a user's perspective a seamless access to media file depository is provided (e.g., typically all files in the depository seem to be virtually present on the portable device), and a user's manual interaction (e.g., selection of files based on memory requirement of the portable unit) is mitigated. The download engine can further include a contextualization component that analyzes context of user related information (e.g., activities, location, profile, demographics, environment and the like) to select the media files that are to be downloaded—hence; such system abstracts the remote versus local storage concept as it pertains to the portable unit/depository—since from a user's perspective all files of the depository seem to be available on the portable unit with the limited storage capacity.

In a related aspect, by intelligently downloading music to a local cache on the portable unit and populating a memory thereof with content that is germane to the user, a requirement for a user to manually select songs is mitigated. Put differently, cache associated with the portable unit can be flushed and replaced with additional songs, to provide a seamless content experience for the user. Hence, a user typically need not to drag and copy music files to the portable unit and a requirement to constantly monitor the memory space availability can be mitigated (e.g., eliminate process of explicit synchronization with the depository such as copying files, selection of medias.) In addition, a streaming access to content of the depository can also be supplied, wherein users interact with digitally encoded coherent signals in real-time, such as users viewing video streams.

According to a methodology of the subject innovation, the portable device can be initially paired up with the depository, wherein the portable device can initially identify itself to the music depository. Subsequently, information pertaining to playing the music is identified by the download engine (e.g., relevant memory of the portable unit, context of user related information, and the like). The intelligent download engine can then initiate download and fill up the device to the level and capacity designated with digital content most relevant to the user.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an intelligent download engine that automatically downloads media files on to a portable device of a user, in accordance with an aspect of the subject innovation.

FIG. 2 illustrates a contextualization component as part of the intelligent download engine of the subject innovation.

FIG. 3 illustrates a block diagram of a search component as part of the intelligent download engine in accordance with an aspect of the subject innovation.

FIG. 4 illustrates a related methodology of intelligently downloading a digital file in accordance with an aspect of the subject innovation.

FIG. 5 illustrates a further aspect of a smart download of digital media in accordance with a further the subject innovation.

FIG. 6 illustrates an artificial intelligence (AI) component that can be employed to facilitate inference regarding downloads according to an aspect of the subject innovation.

FIG. 7 illustrates a wireless mobile device, which can receive an intelligent download of music in accordance with an aspect of the innovation.

FIG. 8 illustrates an exemplary system that can search for a music file and intelligently download digital media files associated with contextual information of a user from the Internet to a cellular telephone.

FIG. 9 illustrates an exemplary environment for implementing various aspects of the subject innovation.

FIG. 10 is a schematic block diagram of a sample-computing environment that can be employed for intelligently downloading digital files.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

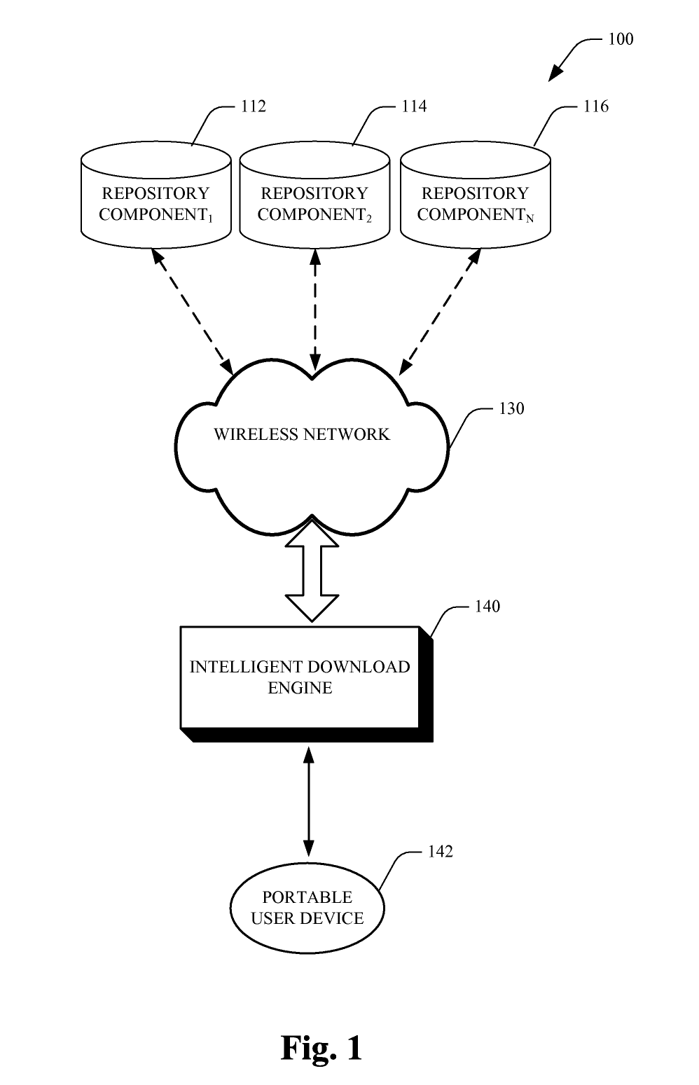

FIG. 1 illustrates a block diagram of an intelligent download engine that automatically downloads media files on to a portable device of a user, in accordance with an aspect of the subject innovation. A user of the portable device 142 can store a collection of media files (e.g., digital music files) on repository components 112, 114, 116 (1 thru N, where N is an integer). The portable device 142 can be automatically populated with media files (e.g., digital music), which are deemed desirable to the user of the portable device 142. Hence from the user's perspective an entire library for each of the repository components 112, 114, 116 seems to be available, since the music is intelligently downloaded to a local cache of the portable user device 142, via the wireless network 130. For example, as music is listened to the local cache of songs in the portable user device 142 can be updated based on what is deemed desirable to the user (e.g., if the user selects a song from a specific Artist, then the entire album from that artist can be locally cached in the background over the network as the user is listening to the first song. Such intelligent algorithm can be adjusted to suit a variety of factors, as described in detail infra.)

The repository components 112, 114, 116 can include any type of a device with storage capabilities and a memory which can include read only memory (ROM) and random access memory (RAM). The ROM contains among other code the Basic Input-Output System (BIOS) which can control the basic hardware operations of the repository components 112, 114, 116, and the RAM can function as the main memory into which the operating system and application programs can be loaded. The repository components 112, 114, 116 can also serve as the storage medium for storing information and additional metadata related to the media files such as; music genre; user ranking, purchase info, number of times played, ratings and related data as described in detail infra. For mass media file storage, the repository components 112, 114, 116 can include a hard disk drive (e.g., 10 Gigabyte hard drive), and the like.

The repository components 112, 114, 116 can also be part of a network (e.g., wireless network 130) such as a system area network or other type of network, and can include several hosts, (not shown), which can be personal computers, servers or other types of computers. Such host generally can be capable of running or executing one or more application-level (or user-level) programs, as well as initiating an I/O request (e.g., I/O reads or writes). In addition, the network can be, for example, an Ethernet LAN, a token ring LAN, or a Wide Area Network (WAN). Moreover, such network can also include hardwired and/or optical and/or wireless connection paths. The connections can be shared among a plurality of the repository components 112, 114, 116 that store digital files for the user. Such repository components 112, 114, 116 can further include, personal computers, workstations, televisions, telephones, and the like for example. Moreover, the networks can further include one or more input/output units (I/O units), wherein such I/O units can includes one or more I/O controllers connected thereto, and each of the I/O can be any of several types of I/O devices, such as storage devices (e.g., a hard disk drive, tape drive) or other I/O device. The hosts and I/O units and their attached I/O controllers and devices can be organized into groups such as clusters, with each cluster including one or more hosts and typically one or more I/O units (each I/O unit including one or more I/O controllers). The hosts and I/O units can be interconnected via a collection of routers, switches and communication links (such as wires, connectors, cables, and the like) that connects a set of nodes (e.g., connects a set of hosts and I/O units) of one or more clusters. As such, intelligent download engine 140 can automatically determine processes that are required to anticipate user likelihood of enjoying a song, as described in detail infra.

Moreover, the wireless communication network 130 can be cellular or WLAN communication network; such as Global System for Mobile communication (GSM) networks, Universal Mobile Telecommunication System (UMTS) networks, and wireless Internet Protocol (IP) networks such as Voice over Internet Protocol (VoIP) and IP Data networks

The portable user device 142 can be a hand-held wireless communication device that can communicate with a wireless communication network, (e.g. wireless communication network 130) to upload and download digital information, via a cellular access point and/or via a wireless access network (WLAN) access point, such as a cellular base station, mobile switching center, 802.11x router, 802.16x router and the like. Further examples of the portable user device 142 can include a cellular communication device, a multi-mode cellular device, a multi-mode cellular telephone, a dual-mode cellular device, a dual-mode cellular/WiFi telephone, or like cellular and/or combination cellular/fixed internet protocol (IP) access devices.

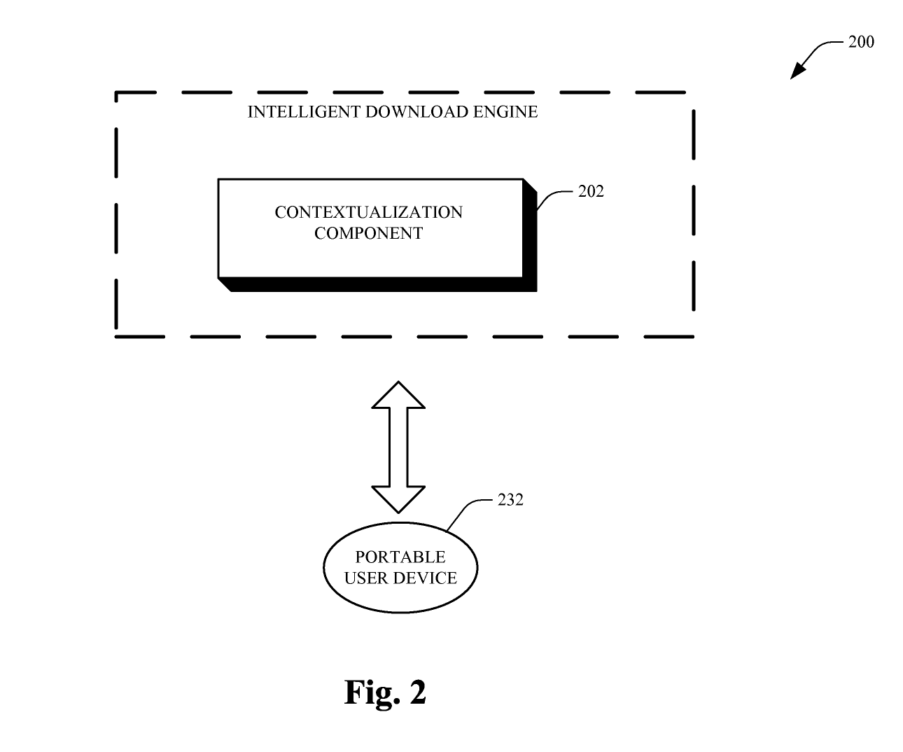

FIG. 2 illustrates a contextualization component 202 as part of the intelligent download engine 200 of the subject innovation. The contextualization component 202 can analyze contextual information related to activities and/or environment of a such as user demographics, user activities, current events, calendar, time of day, to facilitate selection of media files that are deemed desirable by the user for download to the portable device. Accordingly, from a user's perspective a seamless access to music depository is provided and, typically all files of the depository seem to be virtually present on the portable device. Hence, the system abstracts the remote versus local storage concept as pertaining to the portable unit/depository, since from a user's pint of view the files on the depository seem to be available on the portable unit device 232—even though it has limited storage capacity.

For example, location data can be obtained automatically via geographic location technologies, such as global positioning system, tracking information for portable devices carried by the customer, for example. Likewise, profile input can be collected from prior user interaction with the web, e.g., prior user's search, purchase of digital media files such as music files, the topic(s) of the search, the websites visited, pages visited on each website, and if a purchase was made, what was purchased, how the transaction was conducted, modes and delivery times, and the like.

Similarly, the contextualization component 202 can employ user related information such as current user behavior and/or interaction information that is accumulated based on user activity while in a predetermined locality (e.g. hiking outdoors, shopping behavior in retail establishments). Additionally, combination of web-based user activity and shopping activity while in the establishment can be analyzed and processed to select a desired media file to the user, via the display component and/or other types of multimedia presentation systems when the user is detected in close proximity thereto. The model can also include information related to the user's preferences to brand, brand loyalty, pricing, and regularities in product purchases, for example. It is to be appreciated that the intelligent download engine can be part of the portable user device 232, or external thereto.

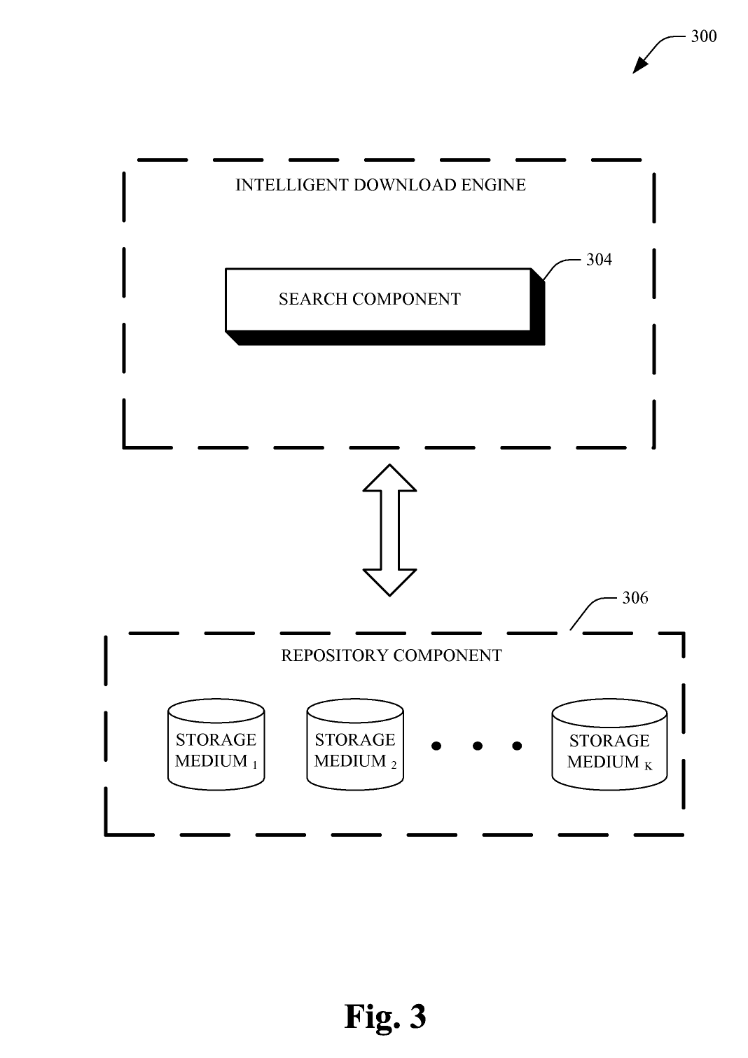

FIG. 3 illustrates a search component 304 as part of the intelligent download engine 300 in accordance with an aspect of the subject innovation. The search component 304 can identify, locate, and/or distinguish between media files (e.g., through music-specific search filters.) Moreover, the search component 304 can search the repository component 306 (1 thru k, where k is an integer) over a communication network and identify media files based on specific filters including, e.g., genre, composer, title, vocalist, musician, producer, album, recording/performance date, record label, conductor, octave, or tempo, and the like, or combinations thereof, associated with a musical composition.

The search component 304 can further locate digital music files associated with the context, and provide network routing information to the intelligent download engine 300. The intelligent download engine 300 can locate digital media files and accompanying to form a connection between one or more entities hosting such files, and download a copy of such files onto the portable device. It is to be appreciated that the intelligent download of the subject innovation can further supply a streaming access to content of the depository. Accordingly, users can interact with digitally encoded coherent signals in real-time (e.g., users viewing video streams.)

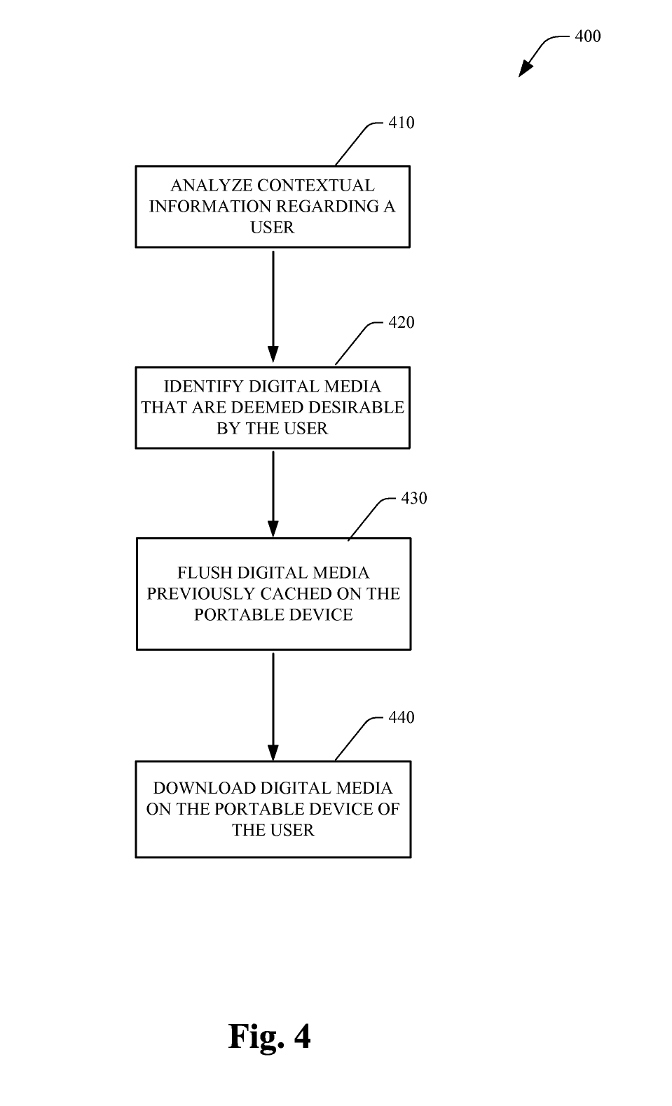

FIG. 4 illustrates a related methodology of intelligently downloading a digital file in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 410 context information regarding a user can be analyzed. Such analysis can include an analysis of contextual information related to activities and/or environment thereof such as user demographics, user activities, current events, calendar, time of day, to facilitate selection of media files that are deemed desirable by the user for download to the portable device. At 420, digital media files that are deemed desirable by the user can be identified in the repositories based on the analysis act. Subsequently, and at 430 music that is previously cached on the portable device can be flushed and removed from the memory of the portable device. Next, and at 440 the digital media files are downloaded to the portable device for listening by the user. Accordingly, from a user's perspective abstracting exists for the remote versus local storage concept as pertaining to the portable unit/depository, as the files of the depository are available on the portable unit with the limited storage capacity.

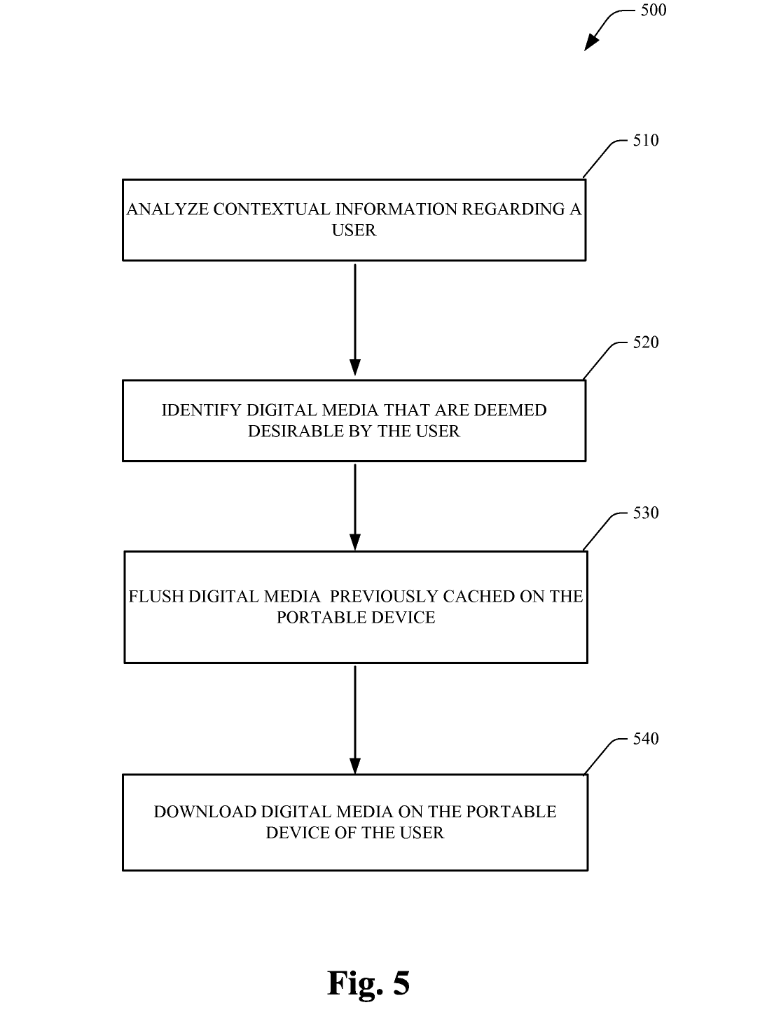

FIG. 5 illustrates a further methodology of a smart download of digital media in accordance with a further the subject innovation. Initially, and at 510 wireless connection can be established between the portable device and the repository of digital files. Next, and at 520 user selects a desired digital media. Subsequently, and at 530 based on such user selection, the download engine supplies an inference regarding the type of digital data that the user is interested in. For example, the user can select a music having a particular genre from a specific album of a singer, and an inference can be made that similar selections are likely to be of interest to the user. At 540 the digital media files of interest are located in the repository and downloaded at 550 to the user portable device. Hence, a seamless access to music depository is provided wherein, typically all files of the depository seem to be virtually present on the portable device.

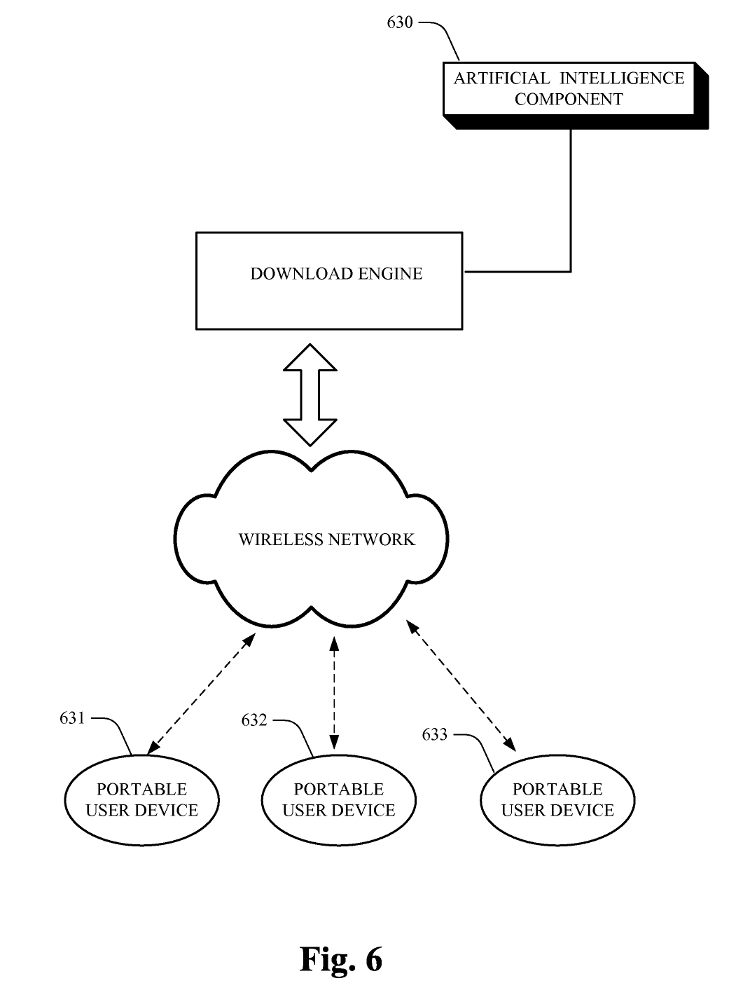

FIG. 6 illustrates an artificial intelligence (AI) component 630 that can be employed to facilitate inferring and/or determining when, where, how to determine an intelligent download from repository to a plurality of portable user devices 631, 632, 633 in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 630 can employ any of a variety of suitable AI-based schemes as described supra in connection with facilitating various aspects of the herein described invention. For example, a process for learning explicitly or implicitly how or which digital media should be downloaded can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

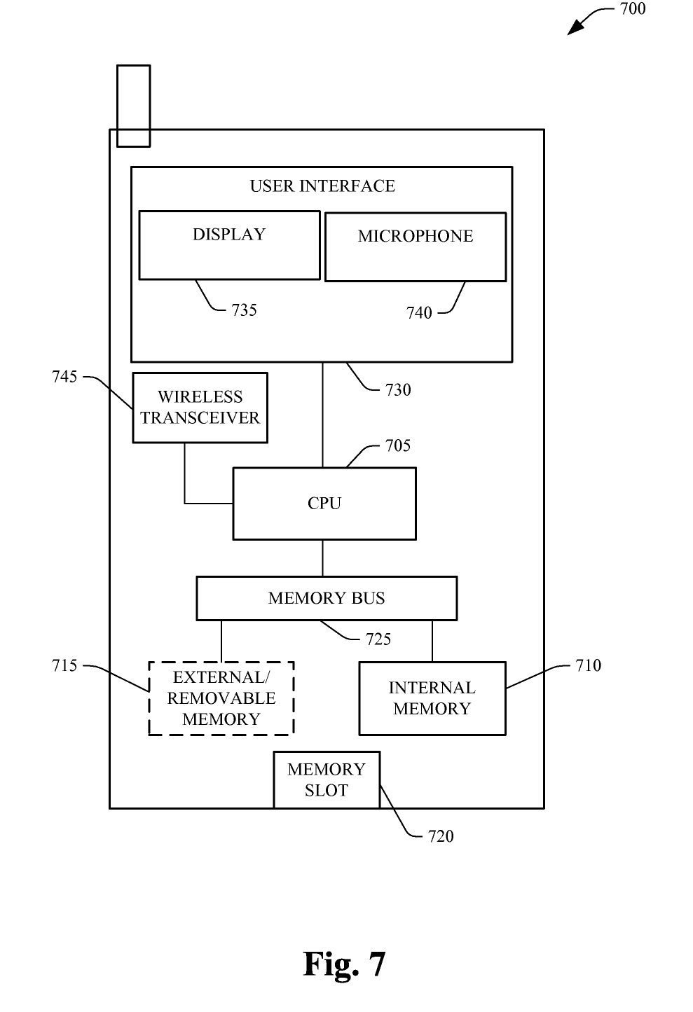

FIG. 7 illustrates a wireless mobile device 700, which can receive an intelligent download of music in accordance with an aspect of the innovation. The mobile device 700 can access a wireless communication network and download and display digital music. Such mobile device 700 can include electronic processing components including a central processing unit (CPU) 705, internal memory 710, external/removable memory 715, and a memory slot 720. CPU 705 can be various commercially available processors, such as a single core processor, a multi-core processor, or other suitable arrangement of processors. Memory bus 725 can be one of several types of bus structure, or combinations thereof, which can electronically interconnect electronic components including, e.g. CPU 705, internal memory, external memory, and the like, to further interconnect to a system bus, a peripheral bus, and a local bus using a variety of commercially available bus architectures. The internal memory 710 can include read-only memory (ROM), random access memory (RAM), high-speed RAM (such as static RAM), EPROM, EEPROM, and/or the like. Additionally or alternatively, the internal memory 710 can include a hard disk drive, upon which program instructions, data, and the like can be retained. External/Removable memory 715 can include removable hard disk drives, flash drives, USB drives, and the like. Memory Slot 720 can include a universal serial bus (USB), a flash drive input slot, removable hard disk drive slots and other memory or media slots that allow removable memory components to connect to CPU 705 through a memory bus. Memory bus 725 couples electronic processing components including, but not limited to, the internal memory 710 and external/removable memory 715 to CPU 705 and can be one of several types of bus structure, or combinations thereof, that may further interconnect to a system bus, a peripheral bus, and a local bus using a variety of commercially available bus architectures.

Wireless transceiver 745 connects CPU 705 with wireless devices or entities operatively disposed in wireless communication, e.g., digital file repositories, desktops, portable computers, portable data assistants, communications satellites, and devices with WiFi and Bluetooth™ wireless technologies. Thus, the communication can be a predefined structure as with a conventional network or simply an ad hoc communication between at least two devices. Wireless transceiver 745 can also be a removable cellular or dual-mode cellular and WiFi device that can connect to a wireless communication network through a cellular, WLAN or other wireless access point. Such aspect of wireless transceiver 745 enables mobile device 700 to download wireless digital device from a wireless communication network through a standard cellular telephone that can form a wired or wireless connection to CPU 705.

User interface 730 includes at least a graphical display 735 and microphone 740 and is coupled with CPU 705. User interface 730 enables external input of instructions to CPU 705 (e.g. via a keypad or keyboard, a pointing device, for example a mouse or trackball) to configure and run applications (e.g. search applications containing music specific search filters) stored on internal memory 710 or removable/external memory 715. User interface 730 can include a music hotkey, hot-button, or software icon that executes an application automatically connecting a user to a wireless communication network through wireless transceiver 745, and opening a browser at a user specified location containing digital music files. User interface 730 can further include features described herein in regard to a user interface for a cellular telephone, such as a sheet music indexing component, selective search component, voice recognition component, audio recognition component or predictive text component. Graphical display 735 can be a CRT or flat panel display e.g. a liquid crystal display (LCD) or plasma display that can graphically display digital sheet music. Microphone 740 is a device that allows the input of analog audio, voice, or speech onto wireless music stand 700. Inputting analog audio files, voice files, or speech can form the basis for a voice or audio recognition search of a wireless communication network or of the Internet as described, supra.

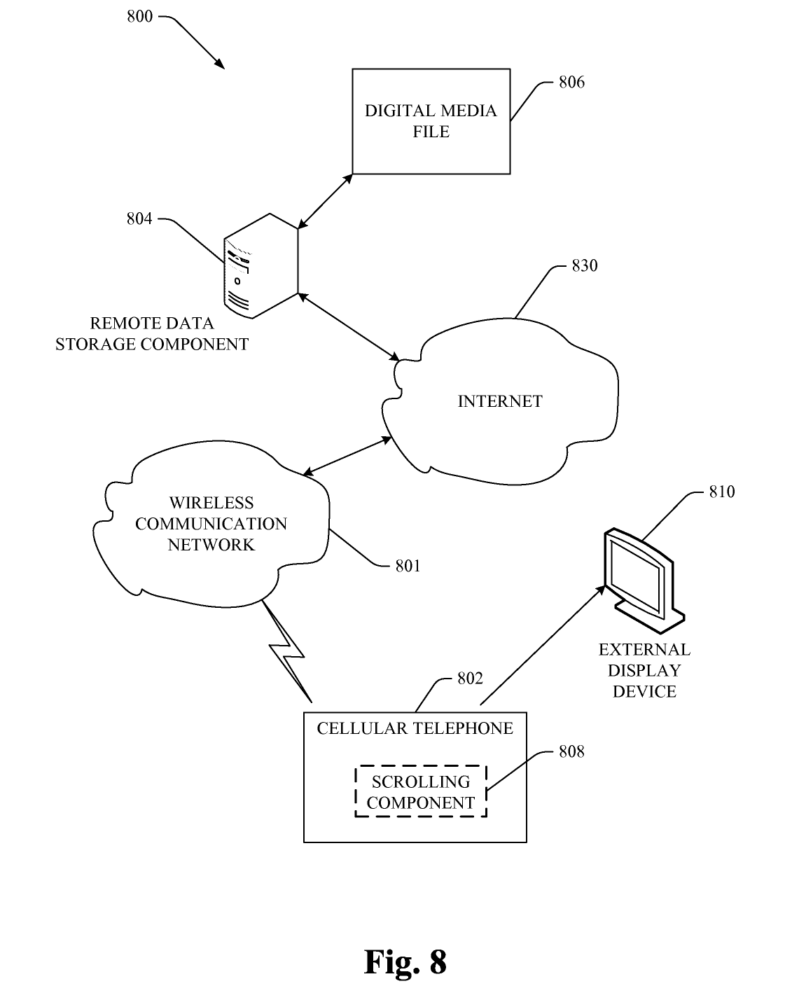

FIG. 8 depicts a system 800 that can search for a music file and intelligently download digital media files associated with contextual information of a user from the Internet to a cellular telephone, and transfer those files to a digital display device. Cellular telephone 802 can be a hand-held wireless communication device that can access a cellular or WLAN access point, search for digital media files via search filters, and intelligently download digital media files associated with the contextual information as described in detail supra to the cellular telephone 802. Wireless communication network 801 can further connect to the Internet 830 via a wired or wireless connection. Internet 830 is connected to and can transfer data between computers, databases, servers, and data storage servers. Remote data storage component 804 can be a physical or virtual device connected to Internet 830 or to wireless communication network 801 capable of storing digital information.

Digital media file 806 can contain information stored in a digital format viewable with typical graphical display applications (e.g. picture view software, word processing software, media players, and the like), and can contain other information about a musical composition, including label identifiers that can facilitate a network search for the file (e.g. name of an author or composer, a genre, a title, date of composition, tempo, octave, vocalist and the like.)

Cellular telephone 802 can search wireless communication network 801 and/or the Internet 830 via musical search filters adapted to expedite efficient search of musical compositions and associated sheet files. Files identified can be downloaded to cellular telephone 802, stored thereon, and displayed via a user interface display. Moreover, a scrolling component 808 can scroll a graphical display of digital music queued for download on the user interface display at a variable predetermined rate of speed set within the user interface. For example, a user can set a speed at which a display of media digital files can be automatically scrolled across a display screen at a rate of speed selected by the user. Moreover, cellular telephone 802 can transmit digital media file 806 to an external display device 810, e.g. via a RF communication protocol such as “Bluetooth”, a wired connection, and the like.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

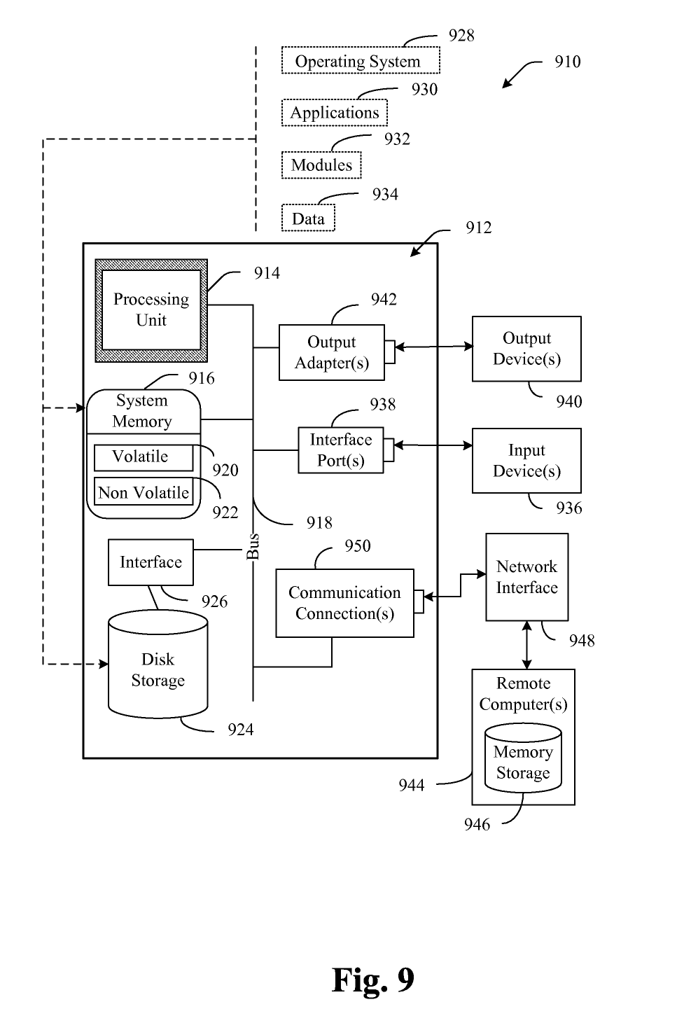

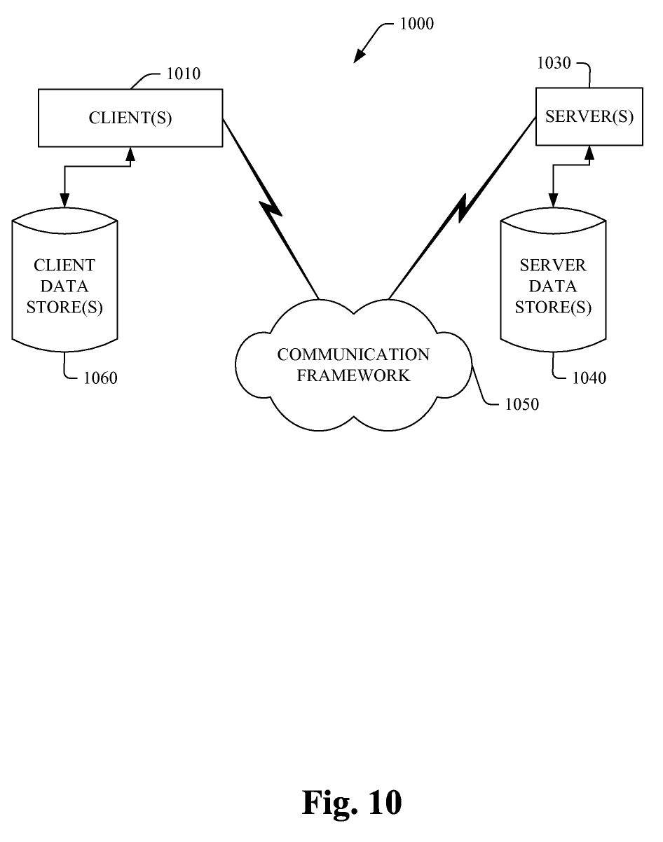

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules.

As used in this application, the terms “component”, “system”, “engine” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for intelligently downloading digital files. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a depository that stores digital media; and
an intelligent download engine that intelligently downloads the digital media into a user's device based on likelihood that such downloaded music is of interest to the user.

2. The computer implemented system of claim 1, the download engine further comprising a contextualization component that analyzes context of user related information.

3. The computer implemented system of claim 1 further comprising a scrolling component that enables a scroll of digital music that is queued for download.

4. The computer implemented system of claim 1 further comprising an artificial intelligence component that facilitates download music of interest to the user.

5. The computer implemented system of claim 1 further comprising a search component that locates digital music files.

6. The computer implemented system of claim 2, the user related information includes physical location of user or activities of user or combination thereof.

7. The computer implemented system of claim 1, the user's device is a wireless mobile device.

8. The computer implemented system of claim 7, the intelligent download engine part of the wireless mobile device.

9. A computer implemented method comprising the following computer executable acts:
inferring whether a digital music is of interest to a user;
automatically downloading the digital music to device of the user.

10. The computer implemented method of claim 9 further comprising supplying a seamless access to a music depository that stores the digital music.

11. The computer implemented method of claim 9 further comprising presenting virtually all files on the music depository from a user's perspective.

12. The computer implemented method of claim 9 further comprising employing a probabilistic or a statistical based analysis or a combination thereof to select the digital music.

13. The computer implemented method of claim 9 further comprising selecting the digital music by the user.

14. The computer implemented method of claim 10 further comprising locating the digital music file in the music depository.

15. The computer implemented method of claim 10 further comprising streaming the digital music to the user.

16. The computer implemented method of claim 10 further comprising flushing out the digital music from the device.

17. The computer implemented method of claim 16 further comprising replacing the digital music with additional digital music.

18. The computer implemented method of claim 16 further comprising anticipating user likelihood of enjoying a song.

19. The computer implemented method of claim 16 further comprising abstracting a remote versus local storage concept as pertaining to the device.

20. A computer implemented system comprising the following computer executable components:
means for intelligently downloading digital music into device of a user based on likelihood that downloaded music is of interest to the user; and
means for analyzing context of user related information.
